(19) United States
(12) Patent Application Publication
(10) Pub. No.: US 2026/0252855 A1
(43) Pub. Date: Aug. 27, 2026

(54) SYSTEM AND METHOD FOR UNCERTAINTY QUANTIFICATION FOR LARGE LANGUAGE MODELS THROUGH CONFIDENCE MEASUREMENT IN SEMANTIC SPACE USING SEMANTIC DENSITY

(71) Applicant: Cognizant Technology Solutions U.S. Corporation, College Station, TX (US)

(72) Inventors: Xin Qiu, Changzhou City (CN); Risto Miikkulainen, Stanford, CA (US)

(73) Assignee: Cognizant Technology Solutions U.S. Corporation, College Station, TX (US)

(21) Appl. No.: 19/063,629

(22) Filed: Feb. 26, 2025

(51) Int. Cl. G06N 3/047

(52) U.S. Cl. CPC G06N 3/047

(57) ABSTRACT

A framework for a new uncertainty metric, semantic density (SD), that can quantify the confidence of large language model (LLM) responses in semantic space is described. Semantic density rebuilds the output probability distribution from a semantic perspective, and extracts an uncertainty indicator analogous to probability density. The proposed semantic density metric has the following advantages: (1) It does not need any further training or fine-tuning of the original LLM; it is an “off-the-shelf” tool that can be directly applied to any pre-trained LLMs without modifying them; (2) it does not pose any restrictions on the problem type; in particular, it works for general free-form generation tasks (3) the returned metric is response-wise, making it possible to evaluate trustworthiness of each response; and (4) it takes the fine-grained semantic differences between resposes into account, which makes uncertainty quantification more precise.

### BACKGROUND

### Field of the Invention

The embodiments are directed generally to the field of calculating large language model (LLM) response certainty.

### DESCRIPTION OF THE RELATED ART

Large language models (LLMs) are type of artificial intelligence (AI) that use deep learning algorithms that can recognize, summarize, translate, predict, and generate content. LLMs are comprised of a neural network core, e.g., transformer architecture neural network, with hundreds of billions, and even trillions, of parameters, trained on massive datasets and have the ability to generate human-like content. Due to the extremely complex nature of the internal workings of an LLM, it is impossible to determine exactly how an LLM processed an input to arrive at a specific output. LLMs are essentially considered black boxes.

LLMs have revolutionalized many domains, such as conversational agents, code generation, and mathematical discovery. Given their ability for general reasoning and adaptability to new tasks, LLMs are utilized increasingly in safety-critical applications and domains, including healthcare, finance and even legal, law enforcement and military-related domains. However, existing LLMs have an unpredictable tendency to hallucinate, leading to misleading information and risky behaviors. And given their black-box nature, responses are generated without quantitative indicators for their uncertainty, making it difficult to evaluate how trustworthy they are. As a result, concerns have been raised about their safety, hindering a deeper utilization of LLMs in risk-sensitive domains.

Although significant resources have been invested in LLM development, leading to a rapid pace in new model releases, very little progress has been made in building an uncertainty quantification framework for LLMs and uncertainty quantification remains a strong focus of the LLM community. An ideal outcome of such a system would be a quantitative metric associated with each response that can be used as an uncertainty/confidence indicator. Users can then build on this metric to evaluate the trustworthiness of LLM responses, e.g., establish an automatic system that triggers a warning if the response confidence is below a pre-defined threshold.

Following this line of thought, several techniques have been proposed in the literature to extract the uncertainty/confidence score from LLMs. In addition to the baselines that directly ask the LLM itself to evaluate its own answers, one further step was to integrate traditional uncertainty estimation/calibration methods into LLMs. However, due to the nature of these traditional methods, they only work on classification problems, not free-form natural language generation (NLG) tasks, which are more general and challenging. Another direction was to fine-tune the original model or train an additional layer or classifier to output uncertainty indicators for the responses. The main drawback to these approaches is that they are not “off-the-shelf” for new tasks and models: additional task-specific training labels of the ground-truth confidence are needed, and the training needs to be done in a model-specific manner, limiting their applicability.

Most importantly, prior work still treats LLM outputs as traditional auto-regressive predictions, i.e., the generated responses are simply handled as sequences of tokens/words, considering only their lexical uncertainty. However, due to the unique nature of free-form NLG, tokens that are lexically different may be semantically similar. Yet semantics is critical in analyzing LLM outputs. In most LLM applications, decisions depend on the semantics of responses, and the same semantics can be stated using different words or sentence structures, leading to different lexical tokens. Therefore, uncertainty in semantic space is a more essential indicator for trustworthiness of LLM responses than lexical uncertainty.

As a fourth direction, semantic entropy is a current SOTA technique that quantifies semantic uncertainty for LLMs. It works by grouping the generated samples based on their semantic equivalence, and then generating an entropy-based indicator as an uncertainty metric. Although its performance is promising compared to the other approaches, it has two intrinsic limitations. First, the returned uncertainty score is prompt-wise, i.e., the semantic entropy is calculated for each prompt, instead of each response. Considering that LLMs can generate diverse responses for the same prompt, using the same uncertainty score for different responses is problematic. Second, semantic entropy only considers semantic equivalence, which is a binary one-cut measurement, i.e., it only returns whether two responses are considered semantically equivalent or not, without reporting how semantically different the responses are. It does not make use of the more fine-grained semantic differences among the responses, which encode information that can make uncertainty quantification more precise.

Besides the above four major directions, uncertainty quantification for LLMs has been explored from other angles as well. These included testing several simple baselines, among which a straightforward measurement of semantic dispersion is robust in evaluating selective response generation and a framework with several variants that use sampling consistency for detecting hallucinations. These two studies assumed a very restricted condition in which the original sampling likelihoods of each response are not used; thus, the uncertainty information extracted by these methods is limited. Another study focused on a specific in-context learning setting, aiming to decompose the uncertainty of LLMs into that caused by demonstration quality and that caused by model configuration. These experiments were limited to classification problems. Similarly, another approach decomposed the uncertainty into data uncertainty and model uncertainty in a prompt-wise approach. Separate studies have explored the connections between hallucination and predictive uncertainty, showing that higher uncertainty is positively correlated with higher chance to hallucinate which validates the importance of a reliable uncertainty measurement in detecting hallucinations of LLMs. Finally, an explorative study using simple baselines on uncertainty measurement for LLMs, highlights the need for more advanced uncertainty quantification methods developed exclusively for LLMs.

Accordingly, there remains a need in the art for an LLM uncertainty quantification framework which can provide a general way to evaluate the trustworthiness of responses generated by LLMs. This ability should be an off-the-shelf response-specific confidence indicator with the capability to analyze the LLM output semantic relationship in a fine-grained manner.

### SUMMARY OF THE EMBODIMENTS

In a first exemplary embodiment, a processor-implemented method for generating a quantitative indicator of confidence in the truth of a target response (y_{*}) generated by a large language model (LLM) responsive to a task prompt (x), includes: sampling multiple M unique reference responses (yᵢ) to the input task prompt (x) from the LLM, wherein i=1, 2, . . . , M; analyzing a semantic relationship between the M unique reference responses (yᵢ) with the the input task prompt (x) as context, wherein a semantic relationship expectation output of the analysis includes at least three separate probabilities for (y_{*}) and (yᵢ) to be semantically contradictory, irrelevant and equivalent given input task prompt (x) as context; calculating a kernel function output using the semantic relationship expectation output; and calculating a semantic density, SD, value of (y_{*}) given context (x), using the kernel function output, wherein the SD value is a quantitative indicator in interval [0,1] of the confidence in the truth of a target response (y_{*}) generated by the large language model (LLM) responsive to task prompt (x).

In a second exemplary embodiment, a processor-implemented method for generating a large language model (LLM) output response (y_{*}) to a user query (x) to the LLM with a quantitative indicator of confidence in the truth of output response (y_{*}), includes: receiving a user query (x) as initial input to the LLM; generating an LLM output response (y_{*}); generating a quantitative indicator of confidence in the truth of the output response (y_{*}); providing the output response (y_{*}) with the quantitative indicator of confidence to the user, wherein generating the quantitative indicator of confidence in the truth of the output response (y_{*}) includes, sampling multiple M unique reference responses (y) to the input task prompt (x) from the LLM, wherein i=1, 2, . . . , M; analyzing a semantic relationship between each of the M unique reference responses (yᵢ) with the the input task prompt (x) as context, wherein a semantic relationship expectation output of the analysis includes at least three separate probabilities for each (y_{*}) and (yᵢ) to be semantically contradictory, irrelevant and equivalent given input task prompt (x) as context; calculating a kernel function output using the semantic relationship expectation output; and calculating a semantic density, SD, value of (y_{*}) given context (x), using the kernel function output, wherein the SD value is a quantitative indicator in interval [0,1] of the confidence in the truth of the output response (y_{*}).

In a third exemplary embodiment, a system for generating a large language model (LLM) output response (y_{*}) to a user query (x) to the LLM with a quantitative indicator of confidence in the truth of output response (y_{*}), includes: a user interface component for receiving a user query (x) as initial input to the LLM and providing an output response (y_{*}) from the LLM with a quantitative indicator of confidence in the truth thereof to the user; a core component for generating the LLM output response (y_{*}) to the initial input, user query (x); a scoring component for generating a quantitative indicator of confidence in the truth of the output response (y_{*}), wherein the scoring component includes programmed code for; sampling multiple M unique reference responses (yᵢ) to the input query (x) from the core component of the LLM, wherein i=1, 2, . . . , M; analyzing a semantic relationship between each of the M unique reference responses (yᵢ) with the the input query (x) as context, wherein a semantic relationship expectation output of the analysis includes at least three separate probabilities for each (y_{*}) and (yᵢ) to be semantically contradictory, irrelevant and equivalent given input query (x) as context; calculating a kernel function output using the semantic relationship expectation output; and calculating a semantic density, SD, value of (y_{*}) given context (x), using the kernel function output, wherein the SD value is a quantitative indicator in interval [0,1] of the confidence in the truth of the output response (y_{*}).

### BRIEF SUMMARY OF THE FIGURES

Example embodiments will become more fully understood from the detailed description given herein below and the accompanying drawings, wherein like elements are represented by like reference characters, which are given by way of illustration only and thus do not limit the exemplary embodiments herein.

FIGS. 1A and 1B are schematics of an exemplary LLM query system incorporating a semantic density confidence metric process in accordance with an embodiment herein;

FIGS. 2A, 2B, 2C and 2D show the resulting AUROC scores of semantic density calculated in accordance with an embodiment herein for 4 datasets and seven LLMs with one to 10 reference responses; and

FIGS. 3A, 3B, 3C, 3D, 3E, 3F and 3G illustrate how semantic density exhibits consistently good AUROC scores across different beam groups.

### DETAILED DESCRIPTION

To fill these gaps, a framework is developed as described in the embodiments herein for a new uncertainty metric, semantic density (SD), that can quantify the confidence of LLM responses in semantic space. Semantic density rebuilds the output probability distribution from a semantic perspective, and extracts an uncertainty indicator analogous to probability density. The proposed semantic density metric has the following advantages: (1) It does not need any further training or fine-tuning of the original LLM; it is an “off-the-shelf” tool that can be directly applied to any pre-trained LLMs without modifying them; (2) it does not pose any restrictions on the problem type; in particular, it works for general free-form generation tasks, i.e., tasks are minimally constrained allowing for a range of responses by the LLM without pre-specified formats or choice constraints (3) the returned metric is response-wise, making it possible to evaluate trustworthiness of each response; and (4) it takes the fine-grained semantic differences between resposes into account, which makes uncertainty quantification more precise.

As discussed further herein, the performance of the semantic density metric was compared with six existing uncertainty quantification methods designed for LLMs across four question-answering benchmark datasets. All the approaches were tested on seven state-of-the-art (SOTA) LLMs, including the latest Llama 3 and Mixtral-8x22B models. Semantic density performed significantly better than the alternatives across the board, suggesting that it forms a promising foundation for evaluating the trustworthiness of LLM responses.

In the LLM literature, the terms “uncertainty” and “confidence” are used in a mixed manner. A number of studies treat uncertainty and confidence as two facets of a single concept, i.e., lower confidence on one particular response corresponds to higher uncertainty (or lower certainty). Other studies try to further differentiate “uncertainty” from “confidence” and only use “uncertainty” to describe the entire output distribution instead of a specific response. Both perspectives fall in the same research area of “uncertainty quantification/estimation”, and the goals of most existing uncertainty/confidence metrics are indeed the same: to provide a quantitative indicator of the trustworthiness of LLM responses. For better coverage and clarity, we use “uncertainty quantification” as a general term to describe work related to the assessment of uncertainty or confidence of LLMs, and “uncertainty” to refer to multiple metrics with mixed term definitions. The proposed semantic density is thus an indicator of response-wise “confidence”.

Initially, given a pre-trained LLM, an input prompt x, and an output sequence y=[y₁, y₂, . . . , y_{L}], where L is the number of tokens in y, the target of the preferred embodiment described herein is to produce a confidence metric that is positively correlated with the probability of y to be true. Note that this metric should be response-wise, i.e., it is calculated for a specific y given x. The metric can be used as a quantitative indicator for whether a specific response y can be trusted.

Theoretically, a semantic space can be any metric space such that a distance function is properly defined to measure the semantic similarity between any two output responses, given the input prompt. Note that such a space is prompt-specific, i.e., each prompt results in a specific semantic space in which the distance function measures the contextual semantic similarity between two responses, treating the prompt as a common context.

More concretely, a semantic space [symbol] (e.g., Oracle® semantic space) is assumed to be a Euclidean space where each point is a D-dimensional vector that represents a contextual embedding of response y given prompt x:

$$v = E ( y \vert x ) , \qquad ( 1 )$$

where v∈ [symbol] , and E(·|·) is an encoder that generates text embeddings with the following properties:
1. All the generated embedding vectors are normalized to have a norm of ½.

$$‖ v ‖ = \frac{1}{2} , for v = E ( y \vert x ) , ∀ x , y . \qquad ( 2 )$$

Whereas most existing text embedding models normalize the output vectors to have a norm of 1, they are rescaled to ½ without changing their direction to make it simpler to integrate them into the kernel function (discussed further below).
2. Given a prompt x and two resulting responses yᵢ and yⱼ, with vᵢ=E(yᵢ|x) and vⱼ=E(yⱼ|x), the following constraints exist for three extreme cases:

$$‖ {v}_{i} - {v}_{j} ‖ = \{ \begin{matrix}0 , if {y}_{i} and {y}_{j} are semantically equivalent given context x \\ \frac{\sqrt{2}}{2} , if {y}_{i} and {y}_{j} are semantically irrelevant given context x \\ 1 , if {y}_{i} and {y}_{j} are semantically contradictory given context x .\end{matrix} \qquad ( 3 )$$

Given the norm requirement in Eq. 2, the above three cases also correspond to vᵢ=vⱼ, vᵢ⊥vⱼ and vᵢ=−vⱼ, respectively. Note that ∥vᵢ−vⱼ∥ is not restricted to the above three values. It can be any value within [0,1], depending on the semantic similarity between y; and y, given x.
3. Given a prompt x and three resulting responses yᵢ, yⱼ and yₖ, with vᵢ=E(yᵢ|x), vⱼ=E(yⱼ|x) and vₖ=E(yₖ|X),
   ∥vᵢ−vⱼ∥<∥vᵢ−vₖ∥, if yᵢ is semantically closer to yⱼ than to yₖ, given context x. (4)

Given the semantic space [symbol] defined above, the underlying probability distribution from which the LLM samples in [symbol] provides critical information: If a response is semantically close to many highly probable samples, it should be more trustworthy compared to a response that is semantically distant from the major sampling possibilities. A classical technique for estimating probability density is kernel density estimation (KDE). However, the standard KDE only works for continuous variables, whereas the LLM outputs are discrete, i.e., sequences of tokens selected from a finite vocabulary. One possible way to extend KDE to accommodate LLM outputs is to build a density estimator as

$$\hat{p} ( {y}_{*} \vert x ) = {\sum }_{i = 1}^{M} {f}_{i} K ( {v}_{*} - {v}_{i} ) = \frac{1}{{Σ}_{i = 1}^{M} {n}_{i}} {\sum }_{i = 1}^{M} {n}_{i} K ( {v}_{*} - {v}_{i} ) \qquad ( 5 )$$

where x is the input prompt, y, is the target response, i.e., the response that needs confidence estimation, and v_{*}=E(y_{*}|x). In total,

$${Σ}_{i = 1}^{M} {n}_{i}$$

reference responses are sampled to facilitate the density estimation, where M is the number of unique samples. Each yᵢ represents a unique sample; nᵢ is the number of occurrences of yᵢ during sampling,

$${f}_{i} = \frac{{n}_{i}}{{Σ}_{i = 1}^{M} {n}_{i}}$$

is the relative frequency of yᵢ during sampling, and K(·) is a kernel function.

The design of Eq. 5 is similar to an early variant of KDE described in Rajagopalan et. al., A kernel estimator for discrete distributions, Journal of Nonparametric Statistics 4, 4 (1995), 409-426, that was used to handle integer data. However, it has the drawback that it incorporates no knowledge about the sampling probabilities for each yᵢ. It thus requires a large number of samplings, including a sufficient number of duplicated results, to obtain the relative frequency as an empirical approximation of the sampling probability. This cost can become prohibitive for LLMs given how expensive LLM inference generally is.

In contrast with the inherently unknown probability distributions in standard KDE, the output token probabilities can be explicitly calculated in LLM sampling, and with this information, a more sample-efficient estimator can be developed. Given a prompt x and a resulting response y_{*}, the semantic density of y_{*} is defined as

$$S D ( {y}_{*} \vert x ) = \frac{1}{{Σ}_{i = 1}^{M} p ( {y}_{i} \vert x )} {\sum }_{i = 1}^{M} p ( {y}_{i} \vert x ) K ( {v}_{*} - {v}_{i} ) , \qquad ( 6 )$$

where v_{*}=E(y_{*}|x), and vᵢ=E(yᵢ|x) for i=1, 2, . . . , M. The M unique responses yᵢ are the reference responses based on which the semantic density of y_{*} is estimated. K(·) is a kernel function which will be specified in Section 3.4, and p(yᵢ|x) (for i=1, 2, . . . , M) is the probability for the original LLM to generate sequence yᵢ given x. That is

$$p ( {y}_{i} \vert x ) = {\prod }_{j = 1}^{{L}_{i}} p ( {y}_{i , j} \vert {y}_{i , 1} , {y}_{i , 2} , … , {y}_{i , j - 1} , x ) ,$$

where Lᵢ is the number of tokens in yᵢ and p(y_{i,j}|·) is the conditional probability to generate token y_{i,j}. Note that in cases where p(y_{*}|x) is available, y_{*} can also be used as one of the M reference responses. For LLMs, e.g., proprietary LLMs, where access to the output probabilities of generated tokens may not be available, the more expensive variant in Eq. 5 can be considered as an alternative.

One advantage of the semantic density estimator of Eq. 6 is that each result y; only needs to be sampled once; their relative frequency fᵢ can then be estimated as

$${f}_{i} = \frac{p ( {y}_{i} \vert x )}{{Σ}_{i = 1}^{M} p ( {y}_{i} \vert x )} .$$

Given a sampling budget of M reference responses, it is therefore desirable that these M samples are unique (duplications will be removed before calculating Eq. 6) and have high sampling probabilities, so that they can cover more sampling regions in the semantic space. In the current implementation, diverse beam search as described in Vijayakumar et. al., Diverse Beam Search for Improved Description of Complex Scenes, Proceedings of the AAAI Conference on Artificial Intelligence 32, 1 (April 2018), which tends to generate diverse and highly probable responses, is used to sample the M unique reference responses.

In practice, length-normalized probability may be used to correct the length bias in sequence probability. And temperature scaling is a simple yet effective method for calibrating the token probabilities during sampling. Both methods can be seamlessly integrated into semantic density: The p(yᵢ|x) in Eq. 6 can be replaced with

$$\sqrt[{L}_{i}]{p ( {y}_{i} \vert x )} ,$$

and the temperature changed during sampling to calibrate each p(y_{i,j}|·).

In a standard KDE setup, a commonly used kernel for multi-variate cases is the Epanechnikov kernel, which was proved to be the most efficient in terms of asymptotic mean integrated squared error. Its original form is

$$K ( v ) = \frac{Γ ( 2 + \frac{D}{2} )}{{π}^{\frac{D}{2}}} ( 1 - {‖ v ‖}^{2} ) {1}_{‖ v ‖ \leq 1} , \qquad ( 7 )$$

where D is the dimension of vector v, Γ(·) is the gamma function, ∥v∥ is the 2-norm of v, and 1_{condition} equals 1 if the condition is true, 0 otherwise.

In the semantic density estimator use case, one drawback of the original Epanechnikov kernel is that the normalization coefficient

$$\frac{Γ ( 2 + \frac{D}{2} )}{{π}^{\frac{D}{2}}}$$

changes with the dimension D of v. As a result, semantic densities calculated using embeddings with different dimensionalities are incomparable. This issue may limit the flexibility in selecting embedding methodologies for semantic density calculation. However, the normalization coefficient can be removed to make the kernel function simpler and more flexible, without affecting the performance of confidence measurement. The kernel function of Eq. 6 thus becomes

$$K ( {v}_{*} - {v}_{i} ) = ( 1 - {‖ {v}_{*} - {v}_{i} ‖}^{2} ) {1}_{‖ {v}_{*} - {v}_{i} ‖ \leq 1} . \qquad ( 8 )$$

Although the resulting kernel function does not meet the normalization requirement in standard KDE, it fits confidence estimation well. As long as the norm requirements in Eq. 2, 3 and 4 are fulfilled, any embedding models can be used to generate v, regardless of the embedding dimensionalities. The outcome of the kernel function is always within [0,1], and a kernel value of 1, ½, and 0 correspond to semantically equivalent, irrelevant, and contradictory responses, respectively. As a result, the semantic density is also within [0,1], with 1 as the highest semantic density a response can obtain, indicating that all the reference responses are semantically equivalent to it; analogously, it obtains a semantic density of 0 when all reference responses are semantically contradictory to it. This consistency in the value range makes practical applications of semantic density convenient: Practitioners can set a fixed threshold on semantic density to detect unreliable responses.

Although most of the existing text-embedding models work in the semantic space defined above, they do not perform well in measuring semantic similarities. Moreover, they can only consider input texts as a whole instead of doing a contextual encoding on part of the input, i.e., they can only obtain E(x+y) instead of E(y|x), where x+y means a concatenation of x and y.

The natural language inference (NLI) classification model has proven to be effective in analyzing the semantic relationship between LLM responses with the prompt as context. Given a pair of texts, an NLI model performs a classification task and outputs the probabilities for them to be semantically equivalent (“entailment” class), irrelevant (“neutral” class), or contradictory (“contradiction” class). Given the output class probabilities, the expectation of ∥v_{*}−vᵢ∥ can be obtained as

$$\text{?} ( {‖ {v}_{*} - {v}_{i} ‖}^{2} ) = {1}^{2} \cdot {p}_{c} ( {y}_{*} , {y}_{i} \vert x ) + {( \frac{\sqrt{2}}{2} )}^{2} \cdot {p}_{n} ( {y}_{*} , {y}_{i} \vert x ) + {0}^{2} \cdot {p}_{e} ( {y}_{*} , {y}_{i} \vert x ) , = {p}_{c} ( {y}_{*} , {y}_{i} \vert x ) + \frac{1}{2} \cdot {p}_{n} ( {y}_{*} , {y}_{i} \vert x ) \qquad ( 9 )$$

where p_{c}(y_{*},yᵢ|x), pₙ(y_{*},yᵢ|x) and pₑ(y_{*},yᵢ|X) are the probabilities for y_{*} and yᵢ to be semantically contradictory (“c” for “contradiction” class), irrelevant (“n” for “neutral” class) and equivalent (“e” for “entailment” class), respectively, given context x. During implementation, each response y will be concatenated with its prompt x (with prompt placed before the response) to form one text, i.e., x+y. Each input of the NLI model will then be a pair of these texts, analyzing the semantic relationship between two responses given the prompt. The expected value of ∥v_{*}−vᵢ∥² can then be used in Eq. 8 to obtain the kernel function output.

Algorithm 1 describes how the semantic density metric is deployed on a given task and model. The procedure consists of four main steps, i.e., sampling the reference responses, analyzing semantic relationships, calculating the kernel function, and calculating the semantic density.

```
Algorithm 1
REQUIRE:
  y_{*}: target response that needs confidence measurement
  x: original prompt for generating y_{*}
  M: number of unique reference responses to be sampled given x
ENSURE:
  SD(y_{*}|x): semantic density for y_{*} given x
Step 1: Reference Response Sampling:
1: sample M unique reference responses yᵢ (for i = 1, 2, ... , M) with prompt x on the
original LLM using diverse beam search, and record each corresponding length-
$normalized sampling probability \sqrt[{L}_{i}]{p ( {y}_{i} \vert x )}$
Step 2: Semantic Relationship Analysis:
2: for i = 1 to M
3. obtain pc(y_{*}, yᵢ|x) and pₙ (y_{*}, yᵢ |x) using NLI classification model
$4 \text{:} calculate expectation 𝔼 ( {‖ {v}_{*} - {v}_{i} ‖}^{2} ) = {p}_{c} ( {y}_{*} , {y}_{i} \vert x ) + \frac{1}{2} \cdot {p}_{n} ( {y}_{*} , {y}_{i} \vert x )$
Step 3: Kernel Function Calculation:
5: for i = 1 to M do
6: calculate kernel function value using the expectation of ||v_{*} − vᵢ||², given by:
    K(v_{*} − vᵢ ) = (1 − [symbol]  (||v_{*} − vᵢ ||²)) [symbol]
Step 4: Semantic Density Calculation:
$7 \text{:} calculate semantic density \text{:} SD ( {y}_{*} \vert x ) = \frac{1}{{\sum }_{i = 1}^{M} \sqrt[{L}_{i}]{p ( {y}_{i} \vert x )}} {\sum }_{i = 1}^{M} \sqrt[{L}_{i}]{p ( {y}_{i} \vert x )} K ( {v}_{*} - {v}_{i} )$
```

In terms of computational cost, only the first two steps involve model inferences. The first step utilizes diverse beam search, in which the group number equals M with one beam in each group, and thus only M inferences need to be done by the original LLM. The second step requires another M or 2M inferences by the NLI classification model, depending on whether the relationship analysis is performed in a bi-directional manner. Considering the fact that NLI models are usually significantly smaller than LLMs (e.g., the Deberta-large-mnli model used in the implementation in this paper only has 1.5 billion parameters), the computational cost is therefore mainly determined by the LLM inferences in the first step.

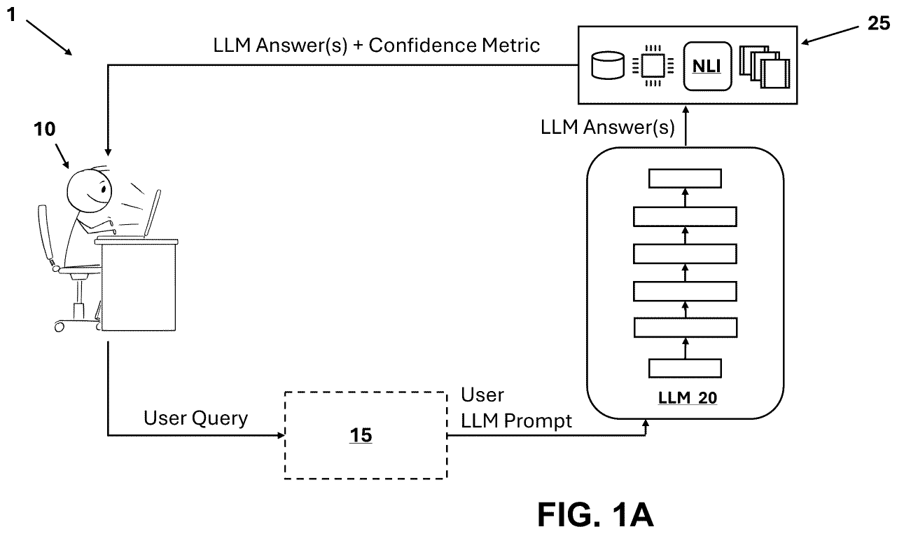

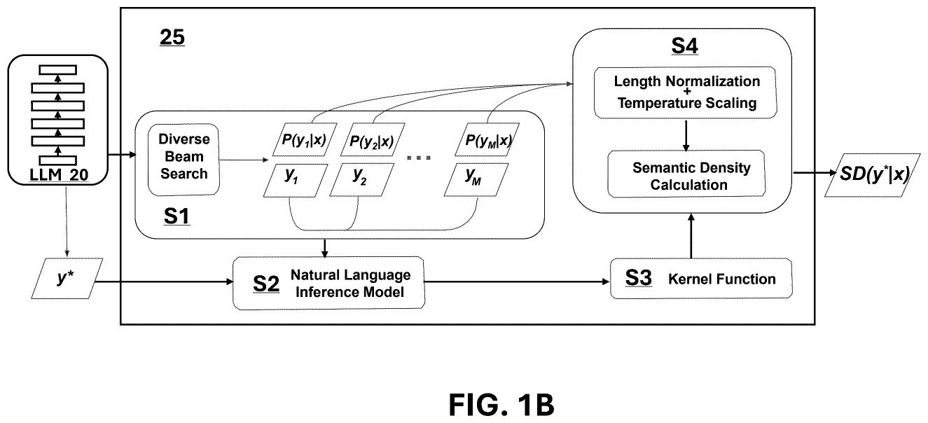

FIG. 1A is a schematic of an exemplary LLM query system 1 incorporating a semantic density confidence metric process as described above. The key components of the system 1 include user 10 for generating the initial user query to the LLM, pre-processing component 15, LLM 20, and semantic density scoring component 25. Pre-processing component 15 is intended to represent, without limitation, any and all pre-processing subcomponents and/or processes which may be implemented to augment the user query to produce the User's LLM prompts, e.g., voice-to-text, RAG, Chatbots, prompt engineering, etc. One skilled in the art will appreciate that the location of computing resources is not limited by location and may be fully or partially cloud-based.

FIG. 1B is a more detailed schematic showing the details of the semantic density scoring component 25 implementing the steps S1 (Reference Response Sampling), S2 (Semantic Relationship Analysis), S3 (Kernel Function Calculation), S4 (Semantic Density Calculation) of Algorithm 1. In a first variation to the implementation and use of semantic density, given a user prompt, we sample multiple responses from the original LLM, calculate semantic density for each of the responses, and select the response with the highest semantic density as the final output. In a second variation, we can predefine a threshold on semantic density, and if any response has a semantic density lower than this threshold, trigger a warning to the user that this response may be a hallucination by the LLM.

Discussed below are the performance evaulations of our semantic density process as compared with six existing uncertainty metrics over various LLMs and benchmarks. Additionally, we provide details of two empirical studies performed to investigate the robustness of semantic density when the number of reference responses and sampling strategy for target response are varied.

In this evaluation, the uncertainty metric is used as a quantitative indicator of how likely the response is going to be correct. Uncertainty values above a threshold are taken as incorrect while those below are taken as correct. For each threshold, the true positive rate vs. false positive rate is then measured. The area under this curve, namely area under receiver operator characteristic curve (AUROC), is calculated for each uncertainty metric. The AUROC score equals the probability that a randomly chosen incorrect response has a higher uncertainty than a randomly chosen correct response. A perfect uncertainty metric would have an AUROC score of 1 while a random metric would have 0.5.

The performance of semantic density (SD) was compared with six existing LLM uncertainty quantification methods: semantic entropy (SE) described in Lorenz Kuhn et. al., Semantic Uncertainty: Linguistic Invariances for Uncertainty Estimation in Natural Language Generation, In The Eleventh International Conference on Learning Representations (2023); P(True) described in Kadavath et. al., Language Models (Mostly) Know What They Know. arXiv:2207.05221 (2022); degree (Deg) described in Lin et. al., Generating with Confidence: Uncertainty Quantification for Black-box Large Language Models, arXiv:2305.19187 (2023); length-normalized likelihood (NL) described in Murray et. al., Correcting Length Bias in Neural Machine Translation, In Proceedings of the Third Conference on Machine Translation: Research Papers, 212-223 (2018); length-normalized entropy (NE) described in Malinin et. al., Uncertainty Estimation in Autoregressive Structured Prediction, In International Conference on Learning Representations (2021); and predictive entropy (PE) described in Kadavath et. al.

These methods were applied to seven state-of-the-art open-source LLMs available from Huggingface Transformers Library and referenced in Wolf et. al., Transformers: State-of-the-Art Natural Language Processing, EMNLP, pages 38-45 (2020) including: Llama-2-13B (Touvron et. al., Llama 2: Open Foundation and Fine-Tuned Chat Models. arXiv:2307.09288 (2023)); Llama-2-70B (Touvron et. al.), Llama-3-8B (AI@Meta, Llama 3 Model Card (2024)), Llama-3-70B (AI@Meta, Llama 3 Model Card (2024)), Mistral-7B (Jiang et. al., Mistral 7B, arXiv:2310.06825 (2023)), Mixtral-8x7B (Jiang et. al., Mixtral of Experts. arXiv:2401.04088 (2024)) and Mixtral-8x22B (Mistral AI team (2024)).

Each LLM was tested on four free-form question-answering datasets commonly used in the literature: CoQA (Reddy et. al., CoQA: A Conversational Question Answering Challenge. Transactions of the Association for Computational Linguistics 7 (2019), 249-266), TriviaQA (Joshi et. al., TriviaQA: A Large Scale Distantly Supervised Challenge Dataset for Reading Comprehension. In Proceedings of the 55th Annual Meeting of the Association for Computational Linguistics (Volume 1: Long Papers), Regina Barzilay and Min-Yen Kan (Eds.). Association for Computational Linguistics, Vancouver, Canada, 1601-1611 (2017)), SciQ (Well et. al., Crowdsourcing Multiple Choice Science Questions. arXiv: 1707.06209 (2017)) and Natural Questions (NQ) (Kwiatkowski et. al., Natural Questions: a Benchmark for Question Answering Research, Transactions of the Association of Computational Linguistics (2019)). For each question, 10 responses were generated using group beam search and used as reference responses in calculating SD, SE, Deg, NE, and PE (note that P(True) and NL do not need reference responses). Each unique response among these 10 will also be used as a target response, i.e., the response that needs an uncertainty estimation, in calculating the AUROC scores of uncertainty metrics.

For all the datasets, an answer is considered to be correct if its Rouge-L to any of the reference answers is larger than 0.3, after trimming the redundant continuations. For the CoQA dataset, the coqa-dev-v1.0 version is used with 1596 questions randomly selected for the experiments, using the Huggingface datasets.train_test_split function with a seed value of 10. Huggingface® is an open-source platform for machine learning (ML) and data science. The prompt format follows the same setup as in Kuhn et al. For TriviaQA, the dataset is loaded with the Huggingface® datasets API. 1705 questions were randomly selected from the validation split for the experiments, using the Huggingface datasets.train_test_split function with a seed value of 10. A 10-shot prompt format is used following the setup in Kuhn et al. For SciQ, the 990 test split dataset from LitCab on Huggingface® is used. The 10-shot prompt format is used following the setup in Kuhn et al. For NQ, the test split from LitCab is used. 1800 questions were randomly selected using the Huggingface datasets.train_test_split function with a seed value of 10. A 10-shot prompt format is used following the setup in Kuhn et al.

Identical target response and reference responses are used for all the tested methods. For SD, SE and Deg, the microsoft/deberta-large-mnli model from the Transformers library from HuggingFace® is used as the NLI classification model. Following Kuhn et al., the probabilities for “contradiction”, “neutral” and “entailment” are averaged bidirectionally. The parametric setup for the uncertainty metrics tested is summarized below. For semantic density (SD), the exactly same steps as described by Algorithm 1 were implemented, with a fixed temperature of 0.1 applied to rescale the value of each token probability during postprocessing. For semantic entropy (SE), the original implementation and parametric setup from the GitHub® web-based training services platform file lorenzkuhn/sematic_uncertainty is used. For the P(true), the original few-shot prompt format from Kadavath et al. is used. For degree (Deg), the “entailment” probability returned by the NLI model (averaged bidirectionally) is used as the similarity between two responses, which is then used as the diagonal element in degree matrix. For length-normalized likelihood (NL), the original form as in Murray et al. was implemented. For length-normalized entropy (NE) and predictive entropy (PE), the implementation from the GitHub® file lorenzkuhn/sematic_uncertainty was used.

All the experiments described herein were run on an Amazon® Web Services (AWS) Elastic Compute Cloud (Amazon EC2) P4de instance with 96 Intel® Xeon® Platinum 8275CL CPU @ 3.00 GHz, 1152 GB memory and 8 NVIDIA A100 (80 GB). The GPU memory required to run the experiments is dependent on the base LLMs, as detailed below:
Llama-2-13B: ~30 GB GPU memory
Llama-2-70B: ~140 GB GPU memory
Llama-3-8B: ~20 GB GPU memory.
Llama-3-70B: ~140 GB GPU memory.
Mistral-7B: ~20 GB GPU memory.
Mixtral-8x7B: ~110 GB GPU memory.
Mixtral-8x22B: ~300 GB GPU memory.
   One skilled in the art will appreciate the alternative cloud-based computing and hardware configurations which may be used in view of specific implementation requirements and resource availability.

Table 1 shows the AUROC scores of each uncertainty metric across different models and datasets, with the best entry in each configuration highlighted in boldface. SD performs best in 26 out of 28 cases for AUROC, demonstrating that it is reliable and robust as a confidence metric for LLM responses. For AUROC, in two cases it is outperformed by Deg. After investigation, the inherent sequence likelihood returned by the original LLM was badly calibrated in these two cases. Deg is the only method that ignores the likelihood information during its calculation, making its performance unaffected by this negative factor. However, for the other 26 cases, SD is able to utilize the likelihood information to its advantage and outperform Deg.

TABLE 1
CoQA

| AUROC | SD | SE | P(True) | Deg | NL | NE | PE |
|---|---|---|---|---|---|---|---|
| Llama-2-13B | 0.783 | 0.633 | 0.594 | 0.734 | 0.709 | 0.629 | 0.647 |
| Llama-2-70B | 0.783 | 0.621 | 0.576 | 0.721 | 0.716 | 0.617 | 0.647 |
| Llama-3-8B | 0.738 | 0.599 | 0.593 | 0.795 | 0.676 | 0.608 | 0.604 |
| Llama-3-70B | 0.789 | 0.608 | 0.670 | 0.729 | 0.698 | 0.587 | 0.641 |
| Mistral-7B | 0.788 | 0.627 | 0.667 | 0.737 | 0.704 | 0.614 | 0.632 |
| Mixtral-8x7B | 0.786 | 0.626 | 0.589 | 0.728 | 0.708 | 0.617 | 0.651 |
| Mixtral-8x22B | 0.791 | 0.614 | 0.614 | 0.726 | 0.700 | 0.604 | 0.649 |

TriviaQA

| AUROC | SD | SE | P(True) | Deg | NL | NE | PE |
|---|---|---|---|---|---|---|---|
| Llama-2-13B | 0.848 | 0.672 | 0.589 | 0.824 | 0.675 | 0.574 | 0.556 |
| Llama-2-70B | 0.829 | 0.677 | 0.556 | 0.787 | 0.714 | 0.582 | 0.566 |
| Llama-3-8B | 0.866 | 0.662 | 0.647 | 0.796 | 0.834 | 0.636 | 0.622 |
| Llama-3-70B | 0.828 | 0.663 | 0.654 | 0.764 | 0.828 | 0.611 | 0.596 |
| Mistral-7B | 0.866 | 0.690 | 0.589 | 0.828 | 0.745 | 0.615 | 0.536 |
| Mixtral-8x7B | 0.846 | 0.685 | 0.562 | 0.797 | 0.795 | 0.644 | 0.605 |
| Mixtral-8x22B | 0.829 | 0.686 | 0.604 | 0.762 | 0.801 | 0.644 | 0.607 |

SciQ

| AUROC | SD | SE | P(True) | Deg | NL | NE | PE |
|---|---|---|---|---|---|---|---|
| Llama-2-13B | 0.757 | 0.570 | 0.572 | 0.727 | 0.693 | 0.513 | 0.574 |
| Llama-2-70B | 0.746 | 0.643 | 0.584 | 0.713 | 0.637 | 0.554 | 0.615 |
| Llama-3-8B | 0.780 | 0.611 | 0.564 | 0.731 | 0.686 | 0.597 | 0.651 |
| Llama-3-70B | 0.771 | 0.613 | 0.556 | 0.706 | 0.724 | 0.558 | 0.520 |
| Mistral-7B | 0.771 | 0.618 | 0.568 | 0.736 | 0.669 | 0.565 | 0.528 |
| Mixtral-8x7B | 0.773 | 0.612 | 0.585 | 0.716 | 0.726 | 0.612 | 0.658 |
| Mixtral-8x22B | 0.775 | 0.620 | 0.602 | 0.719 | 0.715 | 0.602 | 0.628 |

NQ

| AUROC | SD | SE | P(True) | Deg | NL | NE | PE |
|---|---|---|---|---|---|---|---|
| Llama-2-13B | 0.689 | 0.581 | 0.592 | 0.686 | 0.588 | 0.571 | 0.640 |
| Llama-2-70B | 0.676 | 0.545 | 0.531 | 0.691 | 0.567 | 0.573 | 0.620 |
| Llama-3-8B | 0.710 | 0.583 | 0.517 | 0.706 | 0.601 | 0.603 | 0.615 |
| Llama-3-70B | 0.723 | 0.577 | 0.643 | 0.714 | 0.631 | 0.603 | 0.615 |
| Mistral-7B | 0.680 | 0.597 | 0.523 | 0.676 | 0.640 | 0.635 | 0.631 |
| Mixtral-8x7B | 0.729 | 0.599 | 0.576 | 0.720 | 0.654 | 0.603 | 0.608 |
| Mixtral-8x22B | 0.709 | 0.577 | 0.504 | 0.704 | 0.638 | 0.625 | 0.680 |

To confirm that the observed performance differences in Table 1 are statistically significant, a paired t-test (paired by LLM and dataset) was performed between SD and the other metrics. Results are provided in Table 2. The p-values are consistently below 10-6, indicating that the performance gains of SD are strongly statistically significant.

TABLE 2

| SD vs. | SE | P(True) | Deg | NL | NE | PE |
|---|---|---|---|---|---|---|
| | 4.83E−17 | 1.71E−15 | 1.16E−7 | 4.62E−14 | 2.35E−15 | 4.63E−13 |

Two additional empirical studies were performed to evaluate the robustness of semantic density when the number of reference responses varies or the sampling strategy for target response changes.

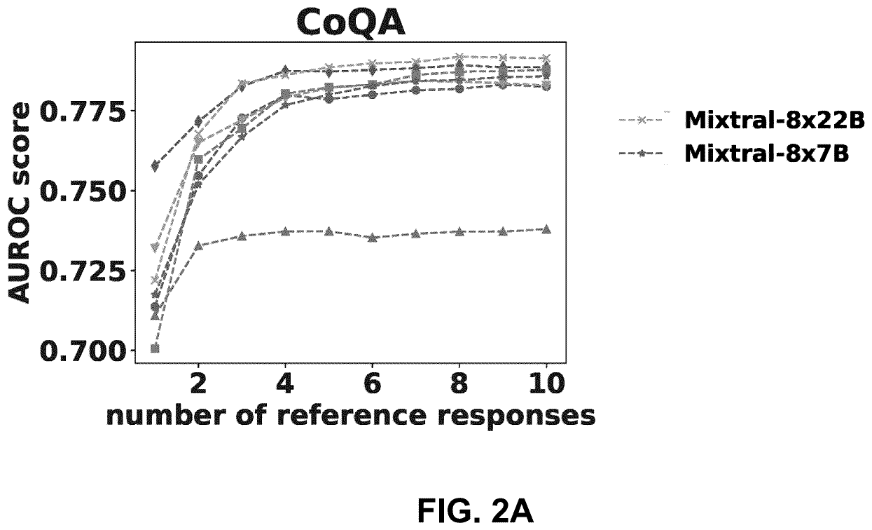

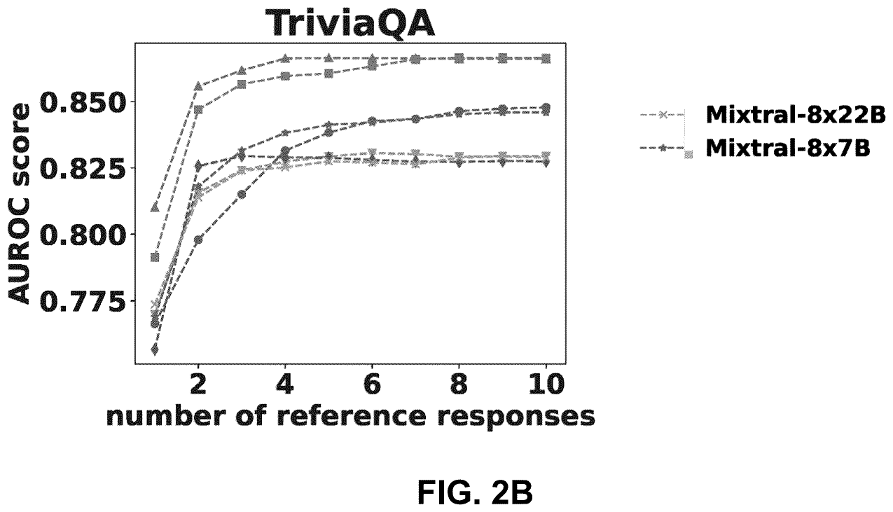

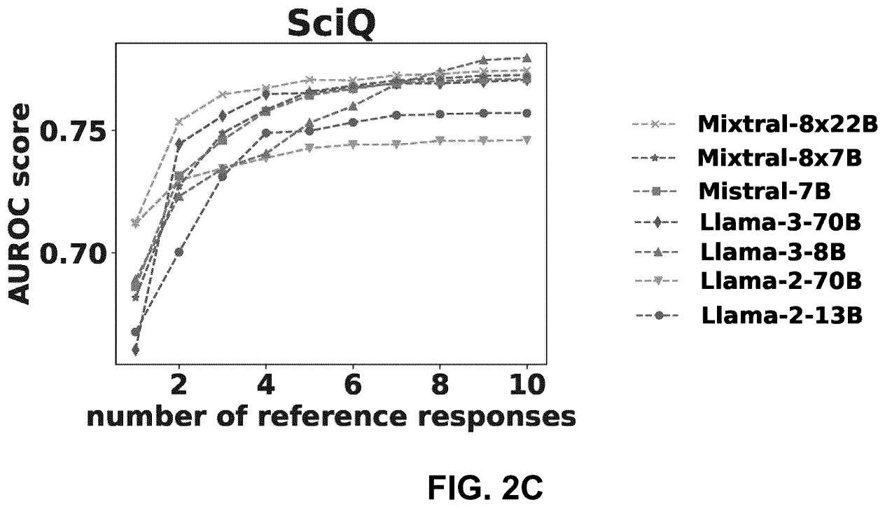

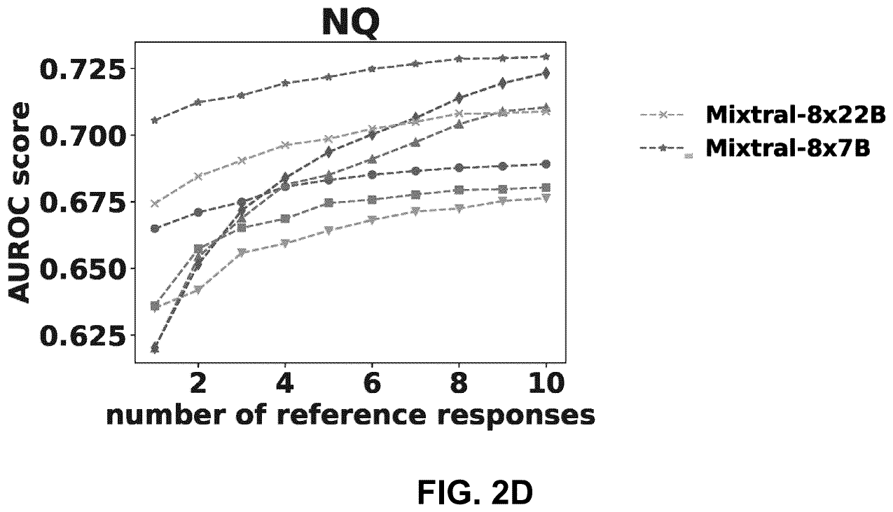

In the first study, the number of reference responses was reduced from 10, which is a standard setup for existing methods as would be understood by one skilled in the art, to one, which is the extreme minimum case. FIGS. 2A, 2B, 2C and 2D show the resulting AUROC scores, covering the same four datasets and seven LLMs. Although performance indeed decreases with fewer reference responses, the decrease is minor as long as the number of references is at least four. This result suggests that semantic density can provide reasonable performance even with a very limited budget for reference sampling.

In real-world applications, users may have different preferences when generating responses. Some may prefer a greedy sampling strategy while others may need diverse responses. The second study thus investigated how each uncertainty metric performs when the target response is sampled using different such strategies. The diverse beam search method inherently utilizes different strategies for each beam group. The first group performs a greedy beam search while later groups encourage more diverse responses. Following the experiments above, the AUROC scores were calculated for target responses from each group separately, and the results averaged over the four datasets.

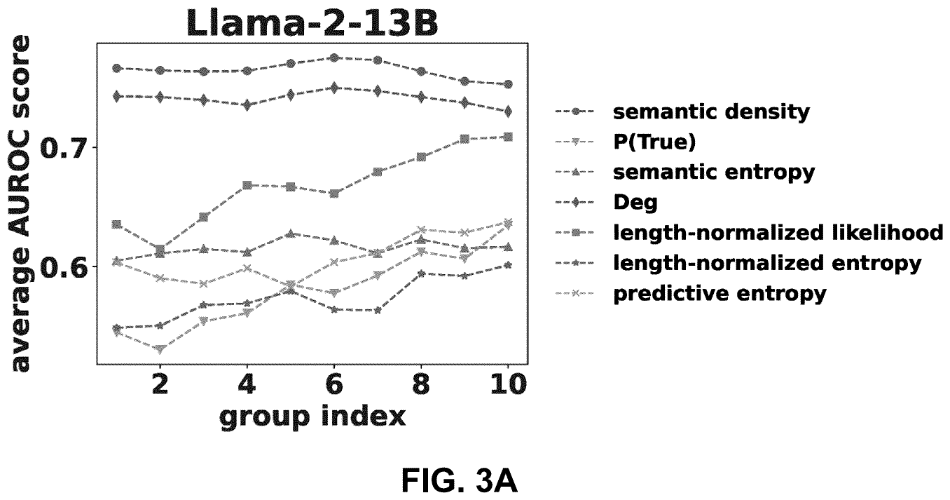

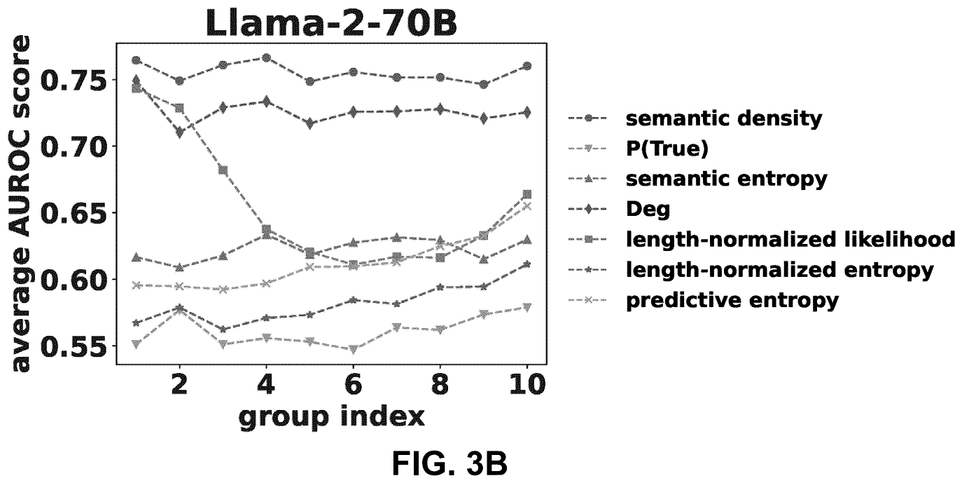

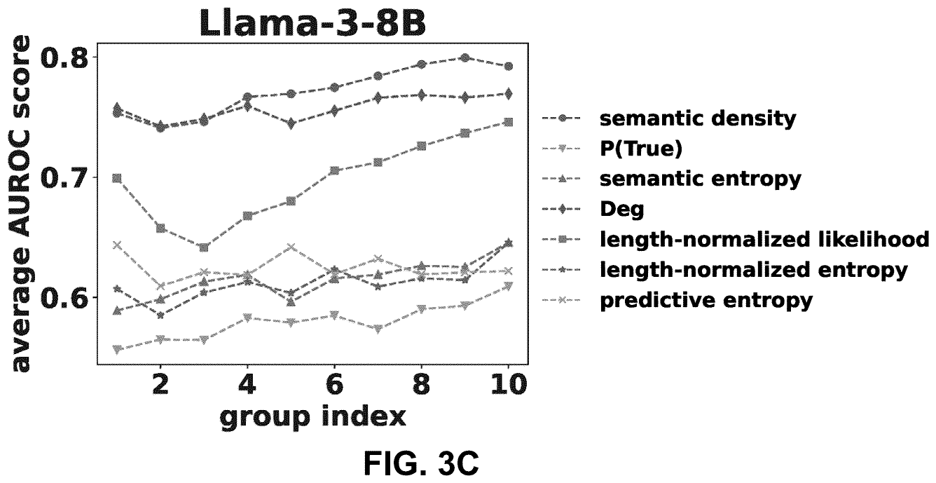

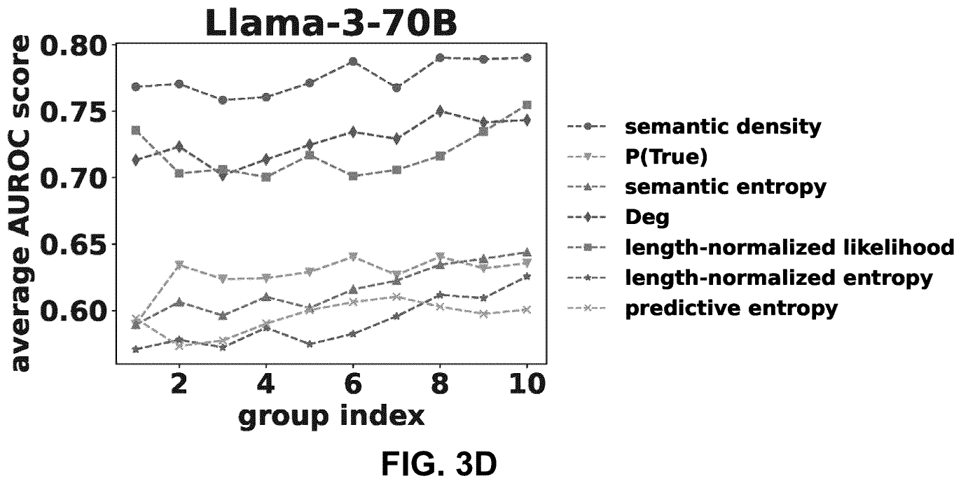

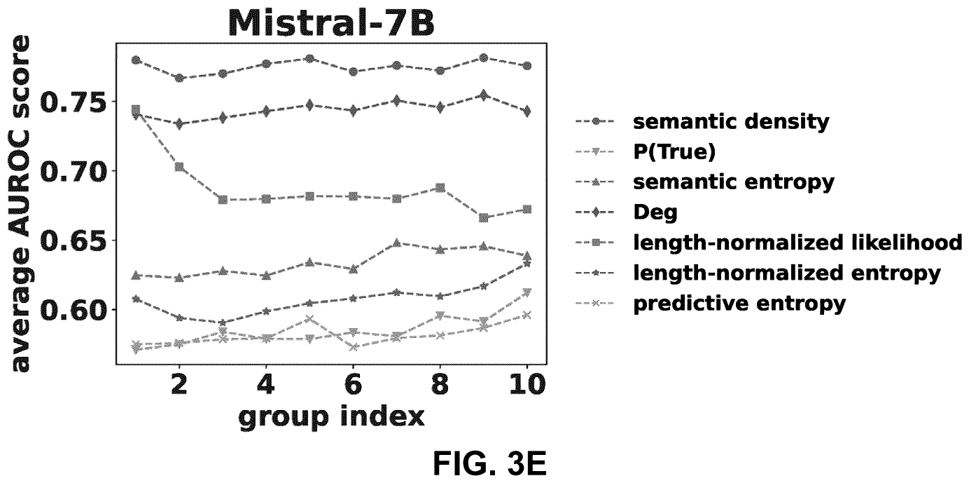

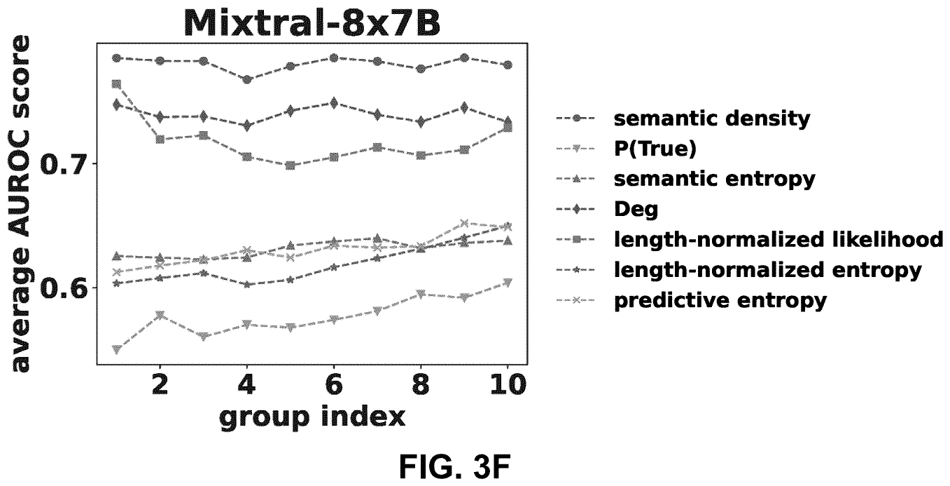

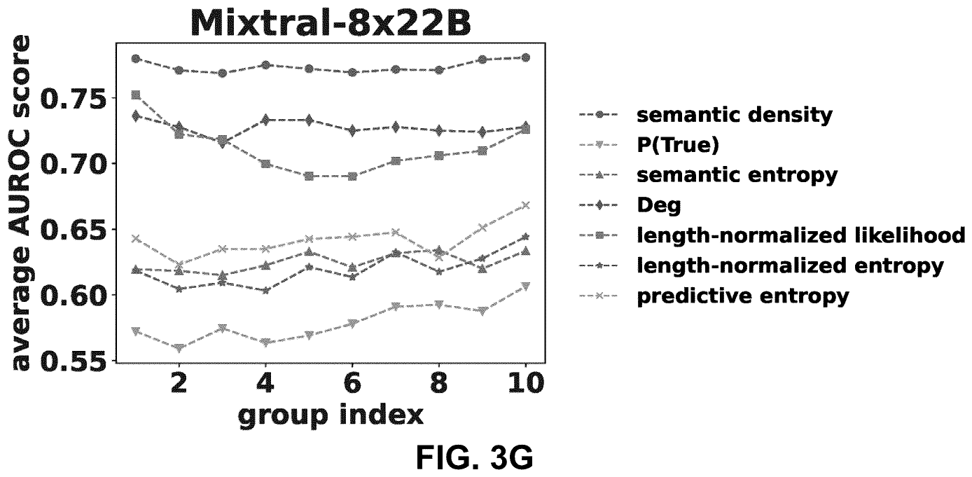

As the results in FIGS. 3A, 3B, 3C, 3D, 3E, 3F and 3G show, semantic density exhibits consistently good AUROC scores across different beam groups. Thus, it is robust against both more greedy and more diverse sampling strategies, thus covering a range of possible user preferences. In contrast, other approaches either perform consistently worse compared to semantic density across different beam groups, or their performance is unstable when the sampling strategy changes. Semantic density exhibits consistently better and stable performance across different groups, compared to other methods.

Though most LLM responses in the experiments described herein are at the sentence level, in an alternative embodiment, semantic density may be extended to long-paragraph responses. A long response can be decomposed into sentence-level claims or factoids, and semantic density can then be applied to estimate the confidence of each claim/factoid.

The modular nature of the framework for measuring semantic density described herein, opens the door to various extensions and improvements. First, new sampling strategies that explicitly encourage a better coverage of semantic space can be developed to generate reference responses. Such extensions should improve the reliability of semantic density further. Second, text embedding methods that can measure contextual semantic similarity between responses more reliably will be helpful as well. Third, kernel functions specifically designed for the semantic space should allow the utilization of semantic relationships more efficiently. Fourth, more precise methods for calibrating inherent token probabilities will form a more reliable base for calculating semantic density.

It is to be understood that the novel concepts described and illustrated herein may assume various alternative configurations, except where expressly specified to the contrary. It is also to be understood that the specific systems, devices and processes illustrated in the attached drawings, and described herein, are simply exemplary embodiments of the embodied concepts defined in the appended claims.

The content of all publications referenced and identified herein is hereby incorporated by reference.

We claim:

1. A processor-implemented method for generating a quantitative indicator of confidence in the truth of a target response (y_{*)} generated by a large language model (LLM) responsive to a task prompt (x), the method comprising:
sampling multiple M unique reference responses (yᵢ) to the input task prompt (x) from the LLM, wherein i=1, 2, . . . , M;
analyzing a semantic relationship between the M unique reference responses (yᵢ) with the the input task prompt (x) as context, wherein a semantic relationship expectation output of the analysis includes at least three separate probabilities for (y_{*}) and (yᵢ) to be semantically contradictory, irrelevant and equivalent given input task prompt (x) as context;
calculating a kernel function output using the semantic relationship expectation output; and
calculating a semantic density, SD, value of (y_{*}) given context (x), using the kernel function output, wherein the SD value is a quantitative indicator in interval [0,1] of the confidence in the truth of a target response (y_{*}) generated by the large language model (LLM) responsive to task prompt (x).

2. The processor-implemented method of claim 1, wherein sampling multiple M unique reference responses (yᵢ) from the LLM implements diverse beam search.

3. The processor-implemented method of claim 2, wherein (yᵢ) are strings of text expressed as sequences of a number of tokens (Lᵢ).

4. The processor-implemented method of claim 3, further comprising recording a corresponding length-normalized sampling probability
$$\sqrt[Li]{p ( {y}_{i} \vert x )}$$
for each (yᵢ) unique reference responses.

5. The processor-implemented method of claim 4, wherein the separate probabilities for (y_{*}) and (yᵢ) to be semantically contradictory p_{c}(y_{*}, yᵢ|x), irrelevant pₙ(y_{*}, yᵢ|x) and equivalent pₑ(y_{*}, yᵢ|x) are determined using a natural language inference (NLI) classification model.

6. The processor-implemented method of claim 5, wherein the semantic relationship expectation output is in the form
$$\text{?} ( {‖ {v}_{*} - {v}_{i} ‖}^{2} ) = {p}_{c} ( {y}_{*} , {y}_{i} \vert x ) + \frac{1}{2} \cdot {p}_{n} ( {y}_{*} , {y}_{i} \vert x ) ,$$
wherein v is a D-dimensional vector that represents a contextual embedding.

7. The processor-implemented method of claim 6, wherein kernel function output is given by: K(v_{*}−vᵢ)=(1− [symbol] (∥v_{*}−vᵢ∥²)) [symbol] .

8. The processor-implemented method of claim 7, wherein SD for (y_{*)} generated by the large language model (LLM) responsive to task prompt (x) is calculated as follows:
$$SD ( {y}_{*} \vert x ) = \frac{1}{{Σ}_{i = 1}^{M} \sqrt[Li]{p ( {y}_{i} \vert x )}} {Σ}_{i = 1}^{M} \sqrt[Li]{p ( {y}_{i} \vert x )} K ( {v}_{*} - {v}_{i} ) .$$

9. A processor-implemented method for generating a large language model (LLM) output response (y) to a user query (x) to the LLM with a quantitative indicator of confidence in the truth of output response (y_{*}), the method comprising:
receiving a user query (x) as initial input to the LLM;
generating an LLM output response (y_{*});
generating a quantitative indicator of confidence in the truth of the output response (y_{*});
providing the output response (y_{*}) with the quantitative indicator of confidence to the user, wherein generating the quantitative indicator of confidence in the truth of the output response (y_{*}) includes,
sampling multiple M unique reference responses (yᵢ) to the input task prompt (x) from the LLM, wherein i=1, 2, . . . , M;
analyzing a semantic relationship between each of the M unique reference responses (yᵢ) with the the input task prompt (x) as context, wherein a semantic relationship expectation output of the analysis includes at least three separate probabilities for each (y_{*}) and (yᵢ) to be semantically contradictory, irrelevant and equivalent given input task prompt (x) as context;
calculating a kernel function output using the semantic relationship expectation output; and
calculating a semantic density, SD, value of (y_{*}) given context (x), using the kernel function output, wherein the SD value is a quantitative indicator in interval [0,1] of the confidence in the truth of the output response (y_{*}).

10. The processor-implemented method of claim 9, wherein sampling multiple M unique reference responses (yᵢ) from the LLM implements diverse beam search.

11. The processor-implemented method of claim 10, wherein (yᵢ) are strings of text expressed as sequences of a number of tokens (Lᵢ).

12. The processor-implemented method of claim 11, further comprising recording a corresponding length-normalized sampling probability
$$\sqrt[Li]{p ( {y}_{i} \vert x )}$$
for each (yᵢ) unique reference responses.

13. The processor-implemented method of claim 12, wherein the separate probabilities for (y_{*}) and (yᵢ) to be semantically contradictory p_{c}(y_{*}, yᵢ|x), irrelevant pₙ(y_{*}, yᵢ|x) and equivalent pₑ(y_{*}, yᵢ|x) are determined using a natural language inference (NLI) classification model.

14. The processor-implemented method of claim 13, wherein the semantic relationship expectation output is in the form
$$\text{?} ( {‖ {v}_{*} - {v}_{i} ‖}^{2} ) = {p}_{c} ( {y}_{*} , {y}_{i} \vert x ) + \frac{1}{2} \cdot {p}_{n} ( {y}_{*} , {y}_{i} \vert x ) ,$$
wherein v is a D-dimensional vector that represents a contextual embedding.

15. The processor-implemented method of claim 14, wherein kernel function output is given by: K(v_{*}−vᵢ)=(1− [symbol] (∥v_{*}−vᵢ∥²)) [symbol] .

16. The processor-implemented method of claim 15, wherein SD for (y_{*}) generated by the large language model (LLM) responsive to task prompt (x) is calculated as follows:
$$SD ( {y}_{*} \vert x ) = \frac{1}{{Σ}_{i = 1}^{M} \sqrt[Li]{p ( {y}_{i} \vert x )}} {Σ}_{i = 1}^{M} \sqrt[Li]{p ( {y}_{i} \vert x )} K ( {v}_{*} - {v}_{i} ) .$$

17. A system for generating a large language model (LLM) output response (y_{*}) to a user query (x) to the LLM with a quantitative indicator of confidence in the truth of output response (y_{*}), the method comprising:
a user interface component for receiving a user query (x) as initial input to the LLM and providing an output response (y_{*}) from the LLM with a quantitative indicator of confidence in the truth thereof to the user;
a core component for generating the LLM output response (y_{*}) to the initial input, user query (x);
a scoring component for generating a quantitative indicator of confidence in the truth of the output response (y_{*}), wherein the scoring component includes programmed code for;
sampling multiple M unique reference responses (yᵢ) to the input query (x) from the core component of the LLM, wherein i=1, 2, . . . , M;
analyzing a semantic relationship between each of the M unique reference responses (yᵢ) with the the input query (x) as context, wherein a semantic relationship expectation output of the analysis includes at least three separate probabilities for each (y_{*}) and (yᵢ) to be semantically contradictory, irrelevant and equivalent given input query (x) as context;
calculating a kernel function output using the semantic relationship expectation output; and
calculating a semantic density, SD, value of (y_{*}) given context (x), using the kernel function output, wherein the SD value is a quantitative indicator in interval [0,1] of the confidence in the truth of the output response (y_{*}).

18. The system of claim 17, wherein the scoring component further includes programmed code for sampling multiple M unique reference responses (yᵢ) from the LLM implements diverse beam search.

19. The system of claim 18, wherein (yᵢ) are strings of text expressed as sequences of a number of tokens (Lᵢ).

20. The system of claim 19, wherein the scoring component further includes programmed code comprising recording a corresponding length-normalized sampling probability
$$\sqrt[Li]{p ( {y}_{i} \vert x )}$$
for each (yᵢ) unique reference responses.

21. The system of claim 20, wherein the scoring component further includes a natural language inference (NLI) classification model for determining the separate probabilities for (y_{*}) and (yᵢ) to be semantically contradictory p_{c}(y_{*},yᵢ|x), irrelevant pₙ(y_{*},yᵢ|x) and equivalent pₑ(y_{*}, yᵢ|x).

22. The system of claim 21, wherein the semantic relationship expectation output is in the form
$$\text{?} ( {‖ {v}_{*} - {v}_{i} ‖}^{2} ) = {p}_{c} ( {y}_{*} , {y}_{i} \vert x ) + \frac{1}{2} \cdot {p}_{n} ( {y}_{*} , {y}_{i} \vert x ) ,$$
wherein v is a D-dimensional vector that represents a contextual embedding.

23. The system of claim 22, wherein kernel function output is given by: K(v_{*}−vᵢ)=(1− [symbol] (∥v_{*}−vᵢ∥²)) [symbol] .

24. The system of claim 23, wherein SD for (y_{*}) generated by the large language model (LLM) responsive to task prompt (x) is calculated by the scoring component as follows:
$$SD ( {y}_{*} \vert x ) = \frac{1}{{Σ}_{i = 1}^{M} \sqrt[Li]{p ( {y}_{i} \vert x )}} {Σ}_{i = 1}^{M} \sqrt[Li]{p ( {y}_{i} \vert x )} K ( {v}_{*} - {v}_{i} ) .$$
